(19) United States
(12) Patent Application Publication
(10) Pub. No.: US 2011/0099854 A1
(43) Pub. Date: May 5, 2011

(54) ARTICLE OF FOOTWEAR

(75) Inventor: David W. Foster, Bolton (GB)

(73) Assignee: Superlite Boot IP Limited, Bolton (GB)

(21) Appl. No.: 12/850,960

(22) Filed: Aug. 5, 2010

Related U.S. Application Data
(63) Continuation of application No. PCT/GB2009/000285, filed on Mar. 2, 2009.

(30) Foreign Application Priority Data
Feb. 5, 2008 (GB) GB 0802026.5

(51) Int. Cl. A43B 7/06; A43B 23/02; B29D 35/00

(52) U.S. Cl. 36/3 A; 36/45; 12/142 V

(57) ABSTRACT

The present invention relates to an article of footwear (1) comprising an upper (5). At least one ventilating groove (3a-i) is formed in the upper (5). The at least one ventilating groove (3a-i) is open to an interior of the article of footwear (1) to facilitate ventilation. The ventilating groove (3A-i) is preferably open along its length. The present application also relates to a method of forming at least one ventilating groove (3a-i) in an article (1).

### RELATED APPLICATION

This application is a continuation of PCT/GB2009/000285, filed on Feb. 3, 2009, which claims priority to GB patent application no. 0802026.5, filed on Feb. 5, 2008. The contents of each of these applications is incorporated herein by reference in their entirety.

The present invention relates to an article of footwear. More particularly, the present invention relates to an article of footwear comprising ventilation means.

It is known from US 2002/0170203 to provide an insert for ventilating a shoe. The insert comprises a first air chamber located at the heel of the shoe to functions as a pump and draw air into the shoe. Air is expelled from the first air chamber when the wearer's weight shifts onto the heel. Separate vent tubes are provided to allow circulate air to be vented from the shoe.

U.S. Pat. No. 6,415,529 and DE 4434599 disclose boots incorporating pumping mechanisms for actively pumping air through tubes provided inside the boots.

These documents also teach providing the pumping mechanism in the heel of the boot for actuation when the wearer's weight shifts to the heel of the boot.

The known ventilation arrangements utilise tubes to distribute air to the required interior regions of the article of footwear. However, the wearer may be aware of the presence of these tubes and over a prolonged period they may prove uncomfortable. Thus, the use of tubes for ventilation are typically restricted to the underfoot area and lateral areas of the article of footwear. The tubes may also become blocked and rendered ineffectual. Moreover, it is not always feasible or desirable to providing a pumping mechanism within the article of footwear.

The present invention, at least in preferred embodiments, attempts to overcome or ameliorate at least some of the problems associated with known ventilation systems for shoes.

Viewed from a first aspect, the present invention relates to an article of footwear comprising an upper having at least one ventilating groove formed therein. The at least one ventilating groove is preferably open to an interior of the article of footwear. Preferably, the at least one ventilating groove is open along its length. The at least one ventilating groove may be formed in the thickness of the upper and preferably does not protrude into the interior of the article of footwear. Thus, at least in preferred embodiments, the at least one ventilating groove is unobtrusive. Preferably, the at least one ventilating groove remains at least partially open when a wearer's foot is located in the article of footwear.

A dedicated pumping mechanism could be provided to draw air into or expel air from the interior of the article of footwear. Preferably, however, the article of footwear is not provided with a dedicated pumping mechanism. In use, adequate ventilation may be provided by the flexing of the article of footwear; convection; and/or movement of the wearer's foot within the article of footwear.

The at least one groove is preferably an elongate recess or depression formed in the upper. Thus, the at least one groove may define a channel open along its length. The or each ventilating groove may be bifurcated. Preferably, however, the at least ventilating groove is non-bifurcated (i.e. a single channel).

The at least one ventilating groove preferably has a substantially uniform cross-section.

A plurality of ventilating grooves may be provided. One or more of the ventilating grooves may be joined together. The ventilating grooves may extend generally longitudinally and/or transversely. The ventilating grooves may, for example, form a lattice arrangement to provide increased ventilation.

One or more ventilating grooves may be provided in a heel region and/or a quarter region of the article of footwear. Since the at least one ventilating groove does not protrude into the interior of the article of footwear in preferred embodiments, said at least one ventilating groove may, in use, extend over the dorsum of a wearer's foot. Preferably, one or more ventilating grooves extend into an anterior region of said upper. One or more ventilating grooves preferably extend into a throat and/or a vamp region of the article of footwear. In use, one or more of said ventilating grooves preferably extend over the dorsum of a wearer's forefoot and/or toes. One or more ventilating grooves preferably extend over the anterior region of the upper and into a toe box portion thereof.

The at least one ventilating groove is preferably at least partially open along its length. Thus, the at least one ventilating groove may provide ventilation along its length. Moreover, the likelihood of the at least one ventilating groove becoming blocked or obstructed may be reduced. This arrangement may also facilitate cleaning of said at least one ventilating groove.

Although not essential, a fabric may be provided over said at least one ventilating groove. The fabric may be an open weave fabric, such as gauze or a mesh. Alternatively, the fabric may be breathable.

A first end of the at least one ventilating groove may be open to an exterior of the article of footwear. To help reduce or minimise the likelihood of water being drawn into the article of footwear, a one-way valve could be provided in said at least one ventilating groove. Preferably, however, the first end of said at least one ventilating groove is located proximal a top of said article of footwear. Most preferably the first end of said at least one ventilating groove is located proximal an opening through which a wearer inserts their foot into the article of footwear. The first end of said at least one ventilating groove may open into a collar provided at the top of said article of footwear. The collar may define an open channel which allows fluid communication between several of said ventilating grooves.

The at least one ventilating groove is preferably formed in the thickness of a sidewall of said upper. The at least one ventilating groove may be cut or machined into the upper. Preferably, however, at least the upper of said article of footwear is moulded and said at least one ventilating groove may be moulded integrally into the upper. The upper is preferably moulded from a plastics material.

At least one ridge or elongate protrusion may be formed in an outside of the upper corresponding to said at least one ventilating groove. Advantageously, the at least one ridge may reinforce the upper in the region of said at least one ventilating groove. In arrangements where the upper is moulded, providing at least one ridge on the outside of the upper may allow the at least one ventilating groove to be formed on an interior thereof.

Viewed from a further aspect, the present invention relates to an article of footwear comprising an upper having at least one ventilating channel provided in an anterior region thereof which, in use, overlies the dorsum of the wearer's forefoot and/or toes. The article of footwear preferably does not comprise a dedicated pumping mechanism.

The article of footwear described herein may be a shoe, a sandal or a boot. The article of footwear may, for example, be a sports shoe or a running shoe. Preferably, however, the article of footwear is a waterproof boot. The boot may extend over the wearer's ankle and preferably also extends over their calf. The boot is preferably knee-length and extends to the wearer's knee or just below.

The article of footwear preferably also comprises a sole. The sole may be formed integrally with the upper or may be formed separately and then attached to the upper.

Viewed from a further aspect, the present invention relates to an upper for an article of footwear, the upper having at least one ventilating groove formed therein. The properties of the at least one ventilating groove formed in the upper may be substantially equivalent to those formed in the upper forming part of the article of footwear described herein.

Viewed from a yet further aspect, the present invention relates to an insert locatable in an article of footwear, the insert comprising at least one ventilating groove formed therein. The properties of the at least one ventilating groove formed in the insert may be substantially equivalent to those formed in the upper of the article of footwear described herein.

Viewed from a still further aspect, the present invention relates to a method of forming at least one ventilating groove in an article using a mould having at least one elongate recess formed therein; the method comprising injection moulding said article; wherein the at least one elongate recess forms a ridge on an exterior of said article and a corresponding ventilating groove on an inside thereof. The article may be at least part of a sole for an article of footwear. Preferably, the article is at least part of an upper for an article of footwear.

Viewed from a yet further aspect, the present invention relates to a mould for forming at least one ventilating groove in an article, the mould comprising at least one elongate recess for defining a ridge on an outside of the article and a corresponding ventilating groove on an inside thereof. The article may be at least part of a sole for an article of footwear. Preferably, the article is at least part of an upper for an article of footwear.

A preferred embodiment of the present invention will now be described, by way of example only, with reference to the accompanying Figures, in which:

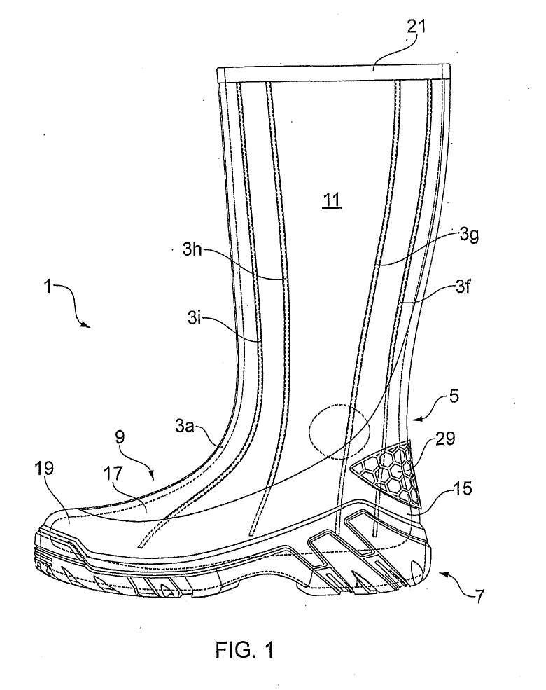

FIG. 1 shows a side elevation of the inside of a waterproof boot incorporating ventilating grooves in accordance with the present invention;

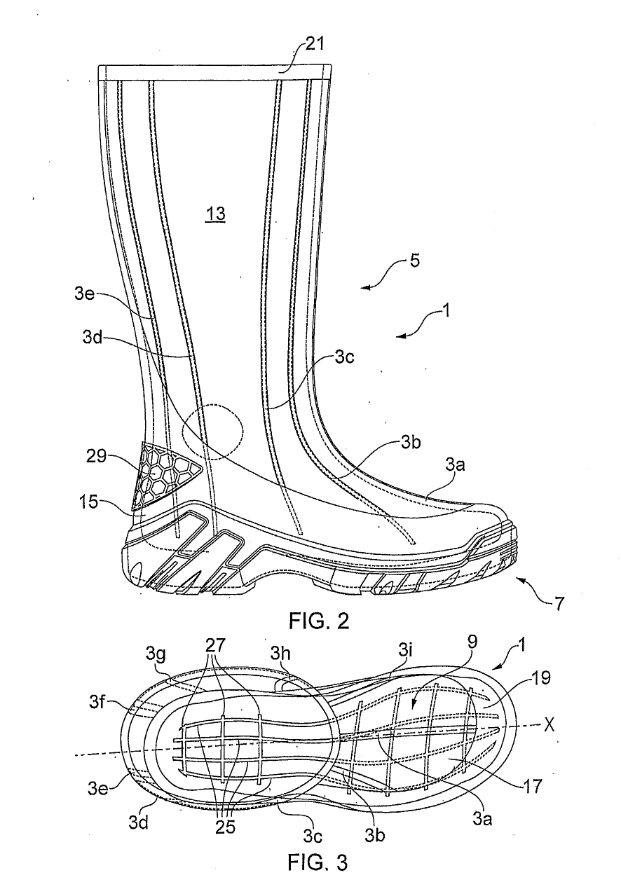

FIG. 2 shows a side elevation of the outside of the waterproof boot according to the present invention; and

FIG. 3 shows a plan view of the waterproof boot according to the present invention.

A waterproof boot 1 incorporating nine (9) internal ventilating grooves 3a-i in accordance with the present invention is illustrated in FIGS. 1 to 3. The boot 1 comprises an upper 5 bonded to a sole 7.

The upper 5 is a one-piece moulding of Ethylene Vinyl Acetate (EVA) plastic formed using injection moulding techniques. The upper 5 comprises an anterior region 9 which extends over the dorsum of a wearer's forefoot and toes; inner and outer flanks 11, 13 which extend over the wearer's calf and their lateral and medial malleoli; and a heel portion 15. The anterior region 9 comprises a vamp 17 and the most anterior aspect of the vamp 17 forms a toe box 19 which overlies the wearer's toes. A collar 21 is provided around the top of the boot 1.

The ventilating grooves 3a-i are integrally moulded on an inside of the upper 5 and are open to the interior of the boot 1 along their length. A first end of the ventilating grooves 3a-i is proximal the top of the boot 1 and the ventilating grooves 3a-i extend downwardly into the boot 1 to facilitate ventilation. The ventilating grooves 3a-i are non-bifurcated channels formed within the thickness of the upper 5 so as not to protrude into the interior of the boot 1. A series of external ridges 23a-i corresponding to the ventilating grooves 3a-i are formed on the outside of the upper 5.

As shown in FIG. 3, the first ventilation groove 3a is substantially coincident with a longitudinal axis X of the boot 1 and extends along the middle of the anterior region 9 into the toe box 19. The second ventilation groove 3b is adjacent the first ventilation groove 3a on the outside of the boot 1 and extends over the anterior region 9 to the region overlying the wearer's lateral metatarsal.

The third ventilation groove 3 is provided on the outside of the boot 1 and extends generally vertically overlying the wearer's lateral malleolus. The fourth to seventh ventilating grooves 3d-g extend generally vertically into the heel portion 15 of the boot 1. The eighth ventilation groove 3h is provided on the inside of the boot 1 and extends generally vertically to the region around the wearer's instep. The ninth ventilation groove 3i is provided on the inside of the boot 1 and extends over the anterior region 9 to the region overlying the wearer's medial metatarsal.

The ventilation grooves 3a-i remain at least partially open when a wearer inserts their foot (not shown) into the boot 1 thereby facilitating ventilation. The ventilation may be a result of convection, but the flexing of the boot 1 as the wearer walks may also promote the circulation of air within the boot 1 via the ventilation grooves 3a-i. Moreover, the movement of the wearer's foot relative to the boot 1 may also serve to draw air into and/or expel air from the boot 1. It has been recognised that the present invention facilitates passive ventilation of the boot 1 and, accordingly, that a dedicated pumping mechanism is not required to provide sufficient ventilation.

A series of longitudinal and transverse underfoot ventilating grooves 25, 27 may optionally be formed in the base of the upper 5 to facilitate circulation of air under the wearer's foot. The longitudinal underfoot ventilating grooves 25 extend lengthwise from the heel 15 to the forefoot region of the boot 1 and the transverse underfoot ventilating grooves 27 extend across the boot 1.

A reinforcing member 29 is provided on the outside of the boot 1 at the heel 15. The reinforcing member 29 has an external hexagonal pattern and is formed integrally with the upper 5.

The method of manufacturing the upper 5 in accordance with the present invention will now be described. The upper 5 is moulded in a single piece from EVA plastics using injection moulding techniques. A mould (not shown) defining the outer profile of the upper 5 is provided. A series of elongate recesses are formed in the mould to define the ridges 23a-i. When fluid pressure is applied to the interior of the mould during the moulding process, for example using a pressurised gas, the molten plastics material is forced into the elongate recesses and the ventilating grooves 3a-i and the underfoot ventilating grooves 25 are formed integrally with the upper 5. Thus, it has been recognised that the ventilating grooves may be formed without an internal mould or the need for a subsequent step to form the ventilation grooves. This moulding process is considered to be patentable independently.

The upper 5 is subsequently removed from the mould and bonded to the sole 5 using conventional techniques.

For the sake of brevity, the present invention has been described with reference to the left boot 1. The right boot would be manufactured using the same moulding process and would incorporate the same features.

It should be noted that the Figures are not necessarily to scale; emphasis instead generally being placed upon illustrating the principles of the present invention.

Various changes and modifications may be made to the present invention without departing from the spirit and scope of the present invention.

1. An article of footwear comprising an upper having at least one ventilating groove formed therein.

2. An article of footwear as claimed in claim 1, wherein at least one ventilating groove extends into an anterior region of said upper.

3. An article of footwear as claimed in claim 2, wherein the anterior region of said upper forms a throat and/or a vamp of the article of footwear.

4. An article of footwear as claimed in claim 1, wherein at least one ventilating groove extends into a toe box portion of said upper.

5. An article of footwear as claimed in claim 1, wherein, in use, at least one ventilating groove extends over the dorsum of a wearer's forefoot and/or toes.

6. An article of footwear as claimed in claim 1, wherein said at least one ventilating groove is at least partially open along its length.

7. An article of footwear as claimed in claim 1, wherein a fabric is provided over said at least one ventilating groove.

8. An article of footwear as claimed in claim 1, wherein a first end of said at least one ventilating groove is proximal a top of said article of footwear.

9. An article of footwear as claimed in claim 8, wherein the first end of said at least one ventilating groove extends to a collar provided at the top of said article of footwear.

10. An article of footwear as claimed in claim 1, wherein said at least one ventilating groove is formed in the thickness of a sidewall of said upper.

11. An article of footwear as claimed in claim 1, wherein a ridge is formed in an outside of the article of footwear corresponding to said at least one ventilating groove.

12. An article of footwear as claimed in claim 1, wherein said upper is moulded from a plastics material.

13. An article of footwear as claimed in claim 12, wherein said at least one ventilating groove is moulded into said upper.

14. An article of footwear as claimed in claim 1, further comprising at least one underfoot ventilating groove.

15. An article of footwear as claimed in claim 1, wherein said article of footwear is a waterproof boot.

16. An upper for an article of footwear, the upper having at least one ventilating groove formed therein.

17. A method of forming at least one ventilating groove in an article using a mould having at least one elongate recess formed therein; the method comprising injection moulding said article; wherein the at least one elongate recess forms a ridge on an exterior of said article and a corresponding ventilating groove on an inside thereof.
